(19) United States
(12) Patent Application Publication
(10) Pub. No.: US 2008/0078349 A1
(43) Pub. Date: Apr. 3, 2008

(54) Intake device of V-type internal combustion engine

(75) Inventors: Takashi Kudo, Saitama (JP); Osamu Emizu, Saitama (JP)

Correspondence Address: BIRCH STEWART KOLASCH & BIRCH, PO BOX 747, FALLS CHURCH, VA, 22040-0747, US

(73) Assignee: HONDA MOTOR CO., LTD.

(21) Appl. No.: 11/905,113

(22) Filed: Sep. 27, 2007

(30) Foreign Application Priority Data
Sep. 29, 2006 (JP) 2006-270022

(51) Int. Cl. F02M 35/104

(52) U.S. Cl. 123/184.34

(57) ABSTRACT

An intake device of a V-type internal combustion engine is provided. In the V-type internal combustion engine, a pair of banks is mounted on an engine body in an approximately V-shape, and a throttle body connected to intake ports of cylinder heads of the banks is arranged between the banks. The throttle body is arranged below uppermost ends of head covers which are respectively mounted on the banks. Therefore, the height of the internal combustion engine can be set as small as possible.

### CROSS-REFERENCE TO RELATED APPLICATIONS

This nonprovisional application claims priority under 35 U.S.C. §119(a) on Patent Application No. 2006-270022, filed in Japan on Sep. 29, 2006, the entirety of which is incorporated herein by reference.

### BACKGROUND OF THE INVENTION

1. Field of the Invention

The present invention relates to an intake device of a V-type internal combustion engine. In the V-type internal combustion engine, a pair of banks is mounted on an engine body in an approximately V-shape, and a throttle body connected to intake ports of cylinder heads of the banks is arranged between the pair of the banks.

2. Background of the Invention

Such an intake device of the V-type internal combustion engine has been already known in, for example, JP-A-2002-256900. However, with respect to the intake device disclosed in the above-mentioned JP-A-2002-256900, the throttle body arranged between both banks is arranged at a position above the engine body. Hence, a height of the internal combustion engine in the vertical direction is increased. Accordingly, it becomes difficult to mount the intake device especially on a motorcycle.

### SUMMARY OF THE INVENTION

The present invention has been made under such circumferences and it is an object of the present invention to provide an intake device of a V-type internal combustion engine which can set a height of the internal combustion engine as small as possible.

To achieve the above-mentioned object, according to a first aspect of the present invention, in an intake device of a V-type internal combustion engine in which a pair of banks is mounted on an engine body in an approximately V-shape, a throttle body connected to intake ports of cylinder heads of the banks is arranged between the pair of the banks, and the throttle body is arranged below the uppermost ends of head covers which are respectively mounted on both banks.

Furthermore, according to a second aspect of the present invention, an electric drive means having an electrically-operated motor is arranged below the throttle body so as to perform open-and-close driving of a throttle valve of the throttle body.

Furthermore, according to a third aspect of the present invention, the single throttle body which makes at least one of a rotational axis of the throttle valve and a rotational axis of the electrically-operated motor substantially orthogonal to a cylinder axis of one of both banks is arranged between both banks.

Furthermore, according to a fourth aspect of the present invention, an intake pipe is connected to the throttle body, and a plurality of branch intake pipes which are provided to the intake pipe are bent toward both banks' side and are connected to the intake ports of the cylinder head of both banks.

According to the first aspect of the present invention, the throttle body is arranged below the uppermost ends of the head covers of both banks. Therefore, it is possible to suppress the height of the internal combustion engine in the vertical direction as low as possible. This allows the mounting of the intake device on a motorcycle without any difficulty.

Furthermore, according to the second aspect of the present invention, the electric drive means is arranged below the throttle body. Therefore, it is possible to form the internal combustion engine in a compact shape by effectively making use of a V-shaped space between both banks.

Furthermore, according to the third aspect of the present invention, it is possible to arrange the single throttle body which corresponds to both banks in the inside of a V-shaped space in a compact shape.

Furthermore, according to the fourth aspect of the present invention, it is possible to simplify the intake connection structure from the single throttle body to the cylinder heads of both banks.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view of a motorcycle of an embodiment of the present invention;

FIG. 2 is a view as viewed in the direction indicated by an arrow 2 in FIG. 1;

FIG. 3 is a view as viewed in the direction indicated by an arrow 3 in FIG. 2;

FIG. 4 is a cross-sectional view taken along a line 4-4 in FIG. 3; and

FIG. 5 is a cross-sectional view taken along a line 5-5 in FIG. 4.

### DETAILED DESCRIPTION OF THE PREFERRED EMBODIMENTS

The present invention will now be described in detail with reference to the accompanying drawings, wherein the same reference numerals will be used to identify the same or similar elements throughout the several views. It should be noted that the drawings should be viewed in the direction of orientation of the reference numerals.

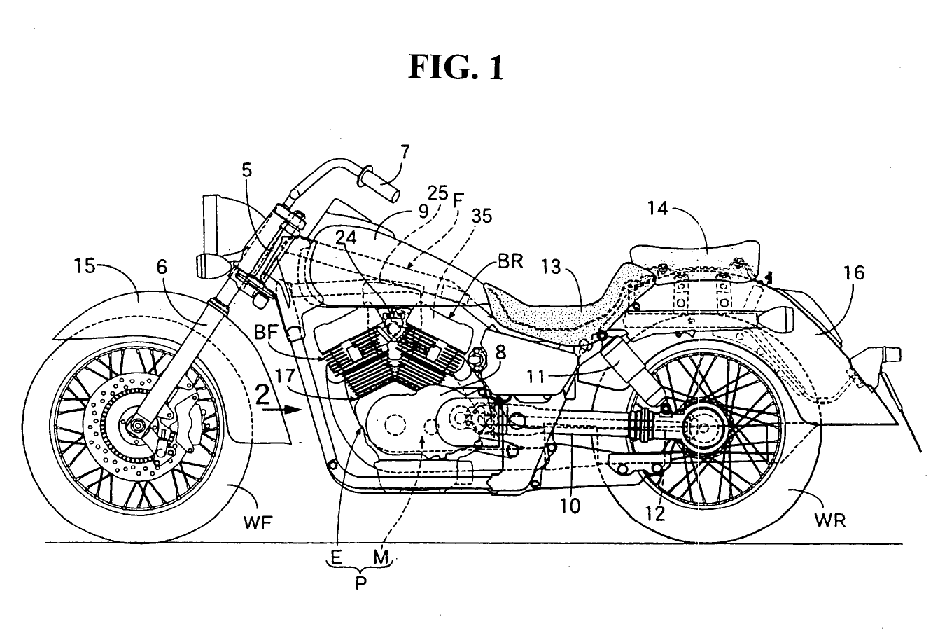

FIG. 1 is a side view of a motorcycle of an embodiment of the present invention. As shown in FIG. 1, a head pipe 5 is mounted on a front end of a vehicle body frame F of a custom-type motorcycle. A front fork 6 which pivotally supports a front wheel WF is steerably supported on the head pipe 5. A steering handle 7 is joined to the front fork 6. Furthermore, a power unit P is mounted on a front portion of the vehicle body frame F. The power unit P is constituted of an internal combustion engine E and a transmission M. The transmission M is housed inside of a crankcase 8 mounted on the internal combustion engine E. A fuel tank 9 is mounted on a front portion of the vehicle body frame F in a state that the fuel tank 9 covers the internal combustion engine E from above.

Behind the above-mentioned power unit P, the front ends of a pair of left and right swing arms 10 are supported on a vehicle body frame F in a vertically rockable manner. The left and right swing arms 10 extend in the longitudinal direction. A rear wheel WR is pivotally supported between the rear ends of both swing arms 10. Furthermore, the rear cushion units 11 are respectively interposed between the vehicle body frame F and the rear portions of both swing arms 10. In addition, the left-side swing arm 10 is formed in a sleeve shape, and a drive shaft 12 for transmitting power from the power unit P to the rear wheel WR is housed in the left-side swing arm 10.

Furthermore, behind the fuel tank 9, a main seat 13 on which a rider sits is mounted on the vehicle body frame F. Behind the main seat 13, a pillion seat 14 for a pillion is mounted on the vehicle body frame F.

A front fender 15 which covers the front wheel WF from thereabove is mounted on the front fork 6, and a rear fender 16 which covers the rear wheel WR from thereabove is mounted on a rear portion of the vehicle body frame F.

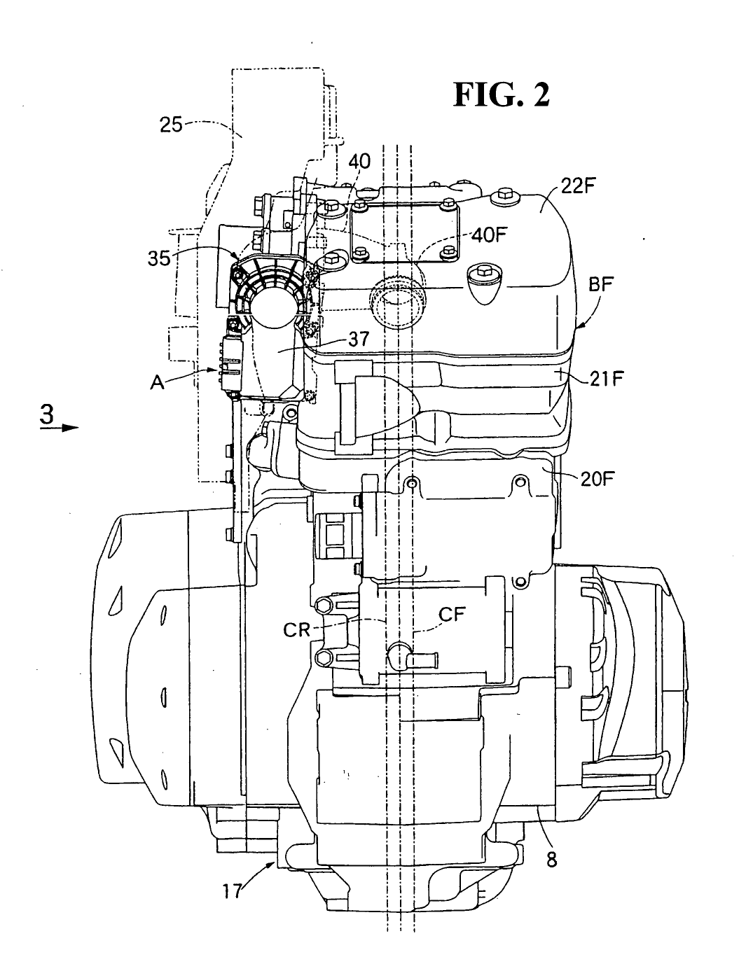

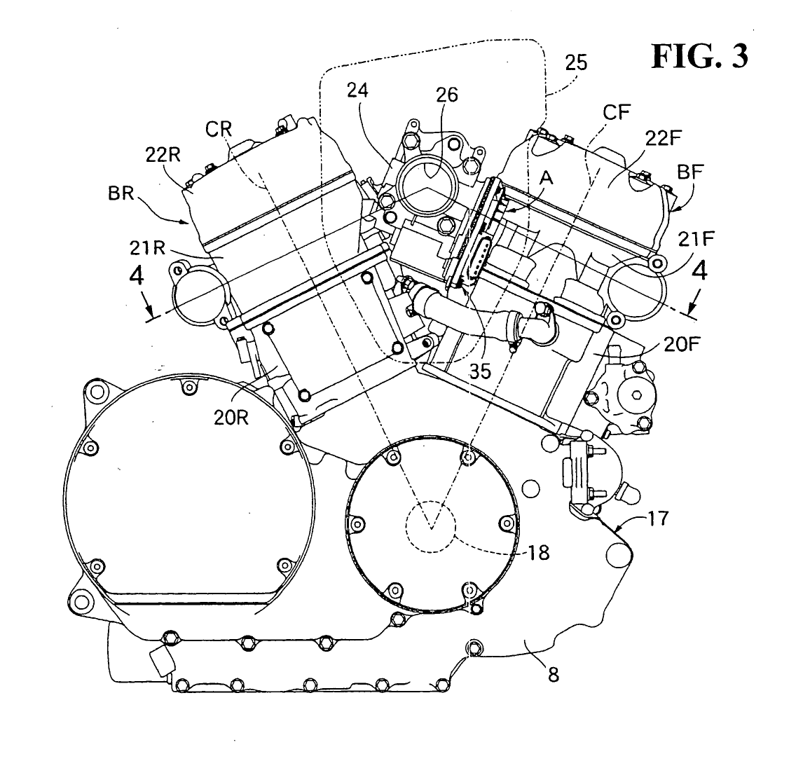

FIG. 2 is a view as viewed in the direction indicated by an arrow 2 in FIG. 1, and FIG. 3 is a view as viewed in the direction indicated by an arrow 3 in FIG. 2. Referring to FIG. 2 and FIG. 3, an engine body 17 of the V-type two-cylinder internal combustion engine E includes a crankcase 8, a pair of front and rear cylinder blocks 20F, 20R, cylinder heads 21F, 21R, and head covers 22F, 22R. The crankcase 8 rotatably supports a crankshaft 18 having an axis thereof extended in the lateral direction of the vehicle body frame F. The front and rear cylinder blocks 20F, 20R are arranged in a substantially upwardly-opened V-shape and are joined to the crankcase 8. The cylinder heads 21F, 21R are respectively joined to the respective cylinder blocks 20F, 20R. The head covers 22F, 22R are respectively joined to upper ends of the cylinder heads 21F, 21R.

A front bank BF is constituted of the cylinder block 20F, the cylinder head 21F and the head cover 22F, and has a cylinder axis CF thereof inclined in the frontward and upward direction. A rear bank BR is constituted of the cylinder block 20R, the cylinder head 21R and the head cover 22R, and has a cylinder axis CR thereof inclined in the rearward and upward direction. The front bank BF and the rear bank BR are contiguously mounted on the crankcase 8 in a state that the front bank BF and the rear bank BR are arranged in a V-shape.

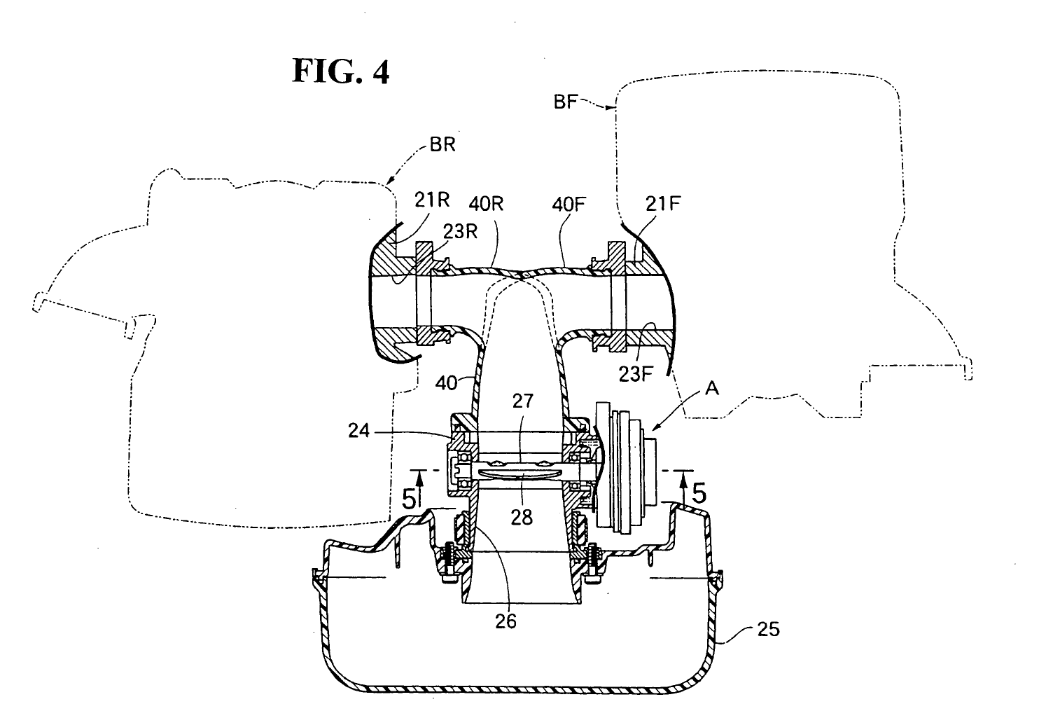

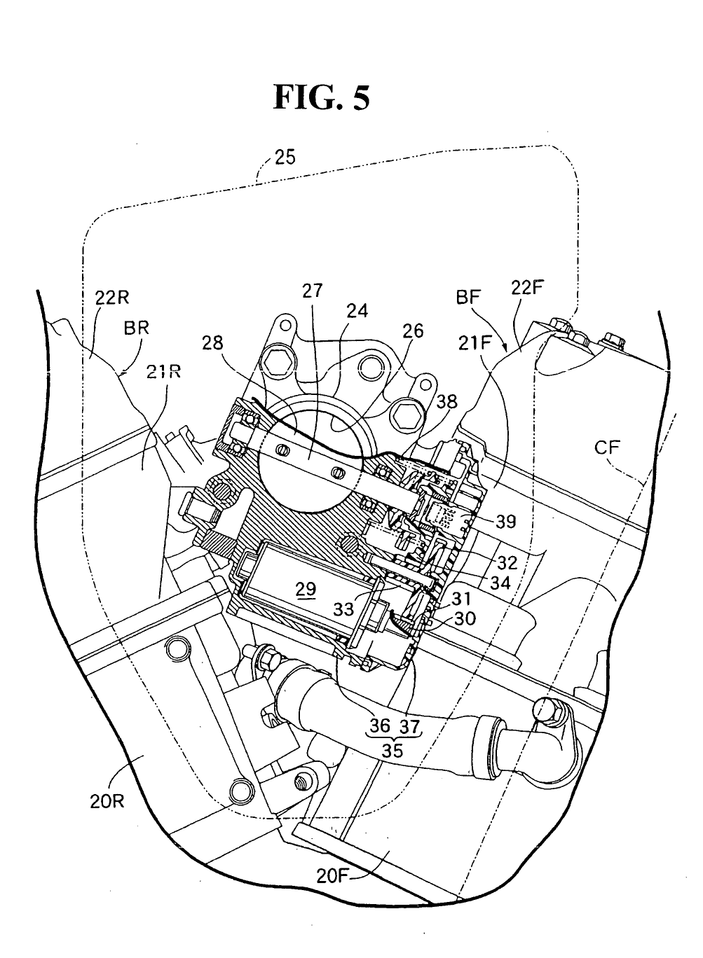

FIG. 4 is a cross-sectional view taken along a line 4-4 in FIG. 3, and FIG. 5 is a cross-sectional view taken along a line 5-5 in FIG. 4. Referring to FIG. 4 and FIG. 5, a single throttle body 24 is arranged between the front bank BF and the rear bank BR. The single throttle body 24 is connected to an intake port 23F, an intake port 23R, and an air cleaner 25. The intake port 23F is formed in the cylinder head 21 of the front bank BF. The intake port 23R is formed in the cylinder head 21R of the rear bank BR.

An intake passage 26 is provided to the throttle body 24 with an axis thereof arranged parallel to the crankshaft 18. The intake passage 26 is communicated with the air cleaner 25. A butterfly-shaped throttle valve 28 is fixedly mounted on a valve shaft 27. The valve shaft 27 transverses the intake passage 26 and is rotatably supported on the throttle body 24.

The throttle body 24 is, as clearly shown in FIG. 3 and FIG. 5, arranged below uppermost ends of head covers 22F, 22R which are respectively mounted on the front and rear banks BF, BR.

The throttle valve 28 of the throttle body 24 is rotated by electric drive means A. As shown in FIG. 5, the electric drive means A is constituted of an electrically-operated motor 29, a drive pinion gear 31, a large-diameter middle gear 32, a small-diameter middle gear 33, and a driven sector gear 34. The electrically-operated motor 29 has a rotational axis thereof arranged parallel to an axis of the valve shaft 27. The drive pinion gear 31 is mounted on an output shaft 30 of the electrically-operated motor 29. The large-diameter middle gear 32 is meshed with the drive pinion gear 31. The small-diameter middle gear 33 is integrally rotated with the large-diameter middle gear 32. The driven sector gear 34 is fixed to the valve shaft 27 and is meshed with the small-diameter middle gear 33. A housing 35 houses the electric drive means A, and is constituted of a housing forming portion 36 and a synthetic-resin-made lid member 37. The housing forming portion 36 is integrally formed with the throttle body 24. The synthetic-resin-made lid member 37 is joined to the housing forming portion 36.

Inside of the housing 35a, a return spring 38 is provided between the throttle body 24 and the driven sector gear 34. The return spring 38 produces a biasing force for returning the throttle valve 28 to a full-closed position. A sensor 39 is mounted on the lid member 37 in a state that the sensor 39 faces an end surface of the valve shaft 27. The sensor 39 detects a rotational position of the valve shaft 27, that is, a degree of opening of the throttle valve 28.

Furthermore, the electric drive means A is arranged below and is mounted on the throttle body 24. Here, the throttle body 24 is arranged between both banks BF, BR such that at least one of a rotational axis of the throttle valve 28, that is, an axis of the valve shaft 27 and a rotational axis of the electrically-operated motor 29 is arranged substantially orthogonal to one of cylinder axes of both banks BF, BR. In the illustrated embodiment, the throttle body 24 is arranged between both banks BF, BR in a state that both the rotational axis of the throttle valve 28, that is, the axis of the valve shaft 27 and the rotational axis of the electrically-operated motor 29 are arranged substantially orthogonal to the cylinder axis CF of the front bank BF.

On a side opposite to the air cleaner 25, an intake pipe 40 communicated with the intake passage 26 is connected to throttle body 24. A plurality of branched intake pipes, for example, branched intake pipes 40F, 40R, are mounted on the intake pipe 40. The branched intake pipes 40F, 40R are respectively bent toward the banks BF, BR. The branched intake pipes 40F, 40R are respectively connected to the intake ports 23F, 23R formed in the cylinder heads 21F, 21R of the banks BF, BR.

The detailed operation of the illustrated embodiment is explained as follows. In this embodiment, the throttle body 24 is arranged between the front and rear banks BF, BR. The front and rear banks BF, BR are mounted on the engine body 17 in a substantially V-shape. The throttle body 24 is connected to the intake ports 23F, 23R formed in the cylinder heads 21F, 21R of the banks BF, BR. Here, the throttle body 24 is arranged below the uppermost ends of the head covers 22F, 22R which are mounted on both banks BF, BR. Accordingly, it is possible to suppress a height of the internal combustion engine E in the vertical direction as low as possible to allow the mounting of the throttle body 24 on the motorcycle without any difficulty.

Furthermore, the electric drive means A includes the electrically-operated motor 29 and opens and closes the throttle valve 28. The electric drive means A is mounted on and below the throttle body 24. Therefore, it is possible to constitute the internal combustion engine E in a compact shape by effectively making use of the V-shaped space defined between both banks BF, BR.

In addition, the single throttle body 24 is arranged between both banks BF, BR in a state that at least one of the rotational axis of the throttle valve 28 and the rotational axis of the electrically-operated motor 28 is arranged approximately orthogonal to one of cylinder axes of the banks BF, BR. In the illustrated embodiment, both of the rotational axes are arranged approximately orthogonal to the cylinder axis CF of the front bank BF. Accordingly, it is possible to arrange the single throttle body 24 which corresponds to both banks BF, BR in the inside of a V-shaped space in a compact shape.

Furthermore, a plurality of branched intake pipes, for example, the branched intake pipes 40F, 40R, are mounted on the intake pipe 40. The branched intake pipes 40F, 40R are respectively bent toward the banks BF, BR, and respectively connected to the intake ports 23F, 23R formed in the cylinder heads 21F, 21R of the banks BF, BR. Accordingly, it is possible to simplify the intake connection structure ranging from the single throttle body 24 to the cylinder heads 21F, 21R of both banks BF, BR.

Although the embodiment of the present invention has been explained heretofore, the present invention is not limited to the above-mentioned embodiment and various design modifications are conceivable without departing from the present invention described in claims.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An intake device of a V-type internal combustion engine in which a pair of banks are mounted on an engine body in an approximately V-shape, the intake device comprising:
a throttle body connected to intake ports of cylinder heads of the banks, the throttle body being arranged between the banks, wherein the throttle body is arranged below uppermost ends of head covers which are mounted on the banks.

2. The intake device of claim 1, further comprising an electric drive device having an electrically-operated motor, wherein the electric drive device is arranged below the throttle body so as to perform open-and-close driving of a throttle valve of the throttle body.

3. The intake device of claim 2, wherein at least one of a rotational axis of the throttle valve and a rotational axis of the electrically-operated motor is substantially orthogonal to a cylinder axis of one of the banks.

4. The intake device of claim 3, wherein the rotational axis of the throttle valve and the rotational axis of the electrically-operated motor are substantially parallel.

5. The intake device of claim 3, wherein the throttle body has an intake passage, the intake passage having an axis substantially parallel to a crankshaft of the engine, the cylinder axis of the one of the banks being substantially orthogonal to the crankshaft of the engine.

6. The intake device of claim 3, further comprising an intake pipe connected to the throttle body, wherein the intake pipe includes a plurality of branched intake pipes, and the branched intake pipes are respectively bent toward the banks and are connected to the intake ports of the cylinder heads of the banks.

7. The intake device of claim 1, wherein the throttle body is located inside a V-shaped space formed by the banks.

8. An intake device of a V-type internal combustion engine in which a pair of banks are mounted on an engine body to form a substantially V-shaped space between the banks, the intake device comprising:
a throttle body connected to intake ports of cylinder heads of the banks, the throttle body being arranged inside the V-shaped space and below uppermost ends of head covers of the banks.

9. The intake device of claim 8, further comprising a drive device arranged below the throttle body so as to open and close a throttle valve of the throttle body, wherein the drive device is located inside the substantially V-shaped space.

10. The intake device of claim 9, wherein the throttle valve is mounted on a valve shaft, and a motor of the drive device rotates the valve shaft to open and close the throttle valve.

11. The intake device of claim 10, wherein at least one of a rotational axis of the valve shaft and a rotational axis of the motor is substantially orthogonal to a cylinder axis of one of the banks.

12. The intake device of claim 11, wherein the rotational axis of the valve shaft and the rotational axis of the electrically-operated motor are substantially parallel.

13. The intake device of claim 11, wherein the throttle body has an intake passage, the intake passage having an axis substantially parallel to a crankshaft of the engine, the cylinder axis of the one of the banks being substantially orthogonal to the crankshaft of the engine.

14. The intake device of claim 13, wherein the valve shaft transverses the intake passage and is rotatably supported on the throttle body.

15. The intake device of claim 8, further comprising an intake pipe connected to the throttle body, wherein the intake pipe includes a plurality of branched intake pipes, and the branched intake pipes are respectively bent toward the banks and are connected to the intake ports of the cylinder heads of the banks, wherein the intake pipe is located inside the substantially V-shaped space.
